(19) United States
(12) Patent Application Publication
(10) Pub. No.: US 2007/0046904 A1
(43) Pub. Date: Mar. 1, 2007

(54) Projector cooling routine

(76) Inventors: Daniel C. Rudolph, Corvallis, OR (US); Reed H. Lacy, Corvallis, OR (US); John Gilman, Corvallis, OR (US); Bert Chen, Hsinchu (TW); Aldon Jiang, Hsinchu (TW); Sammy Hsu, Hsinchu (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,641

(22) Filed: Oct. 31, 2005

Related U.S. Application Data
(60) Provisional application No. 60/711,296, filed on Aug. 24, 2005.

(51) Int. Cl. G03B 21/20

(52) U.S. Cl. 353/85

(57) ABSTRACT

A method for projector cooling includes, upon projector start-up, detecting a device orientation and then initiating a device component cooling routine according to the detected orientation.

### BACKGROUND

Currently, there are a wide-variety of digital projectors commercially available. Most digital projectors include a video decoder and a light engine. The video decoder converts video data into pixel and color data. The video data, for example, may be received by the projector from, a DVD player or the display connection of a personal computer. The pixel and color data is then supplied to the light engine, which converts that data into the actual projected image. The light engine includes a lamp, optics and logic for manipulating the light in order to generate the pixels and color.

There are three main technologies utilized by the light engines of today's projectors: Liquid Crystal Display (LCD), digital micromirror device (DMD), and Liquid Crystal on Silicon (LCOS). Each of these technologies typically relies on a high intensity discharge (HID) lamp to project or throw images onto a screen. A HID lamp has terminal voltage characteristics that vary depending upon the immediate history and the frequency of a stimulus (AC signal) applied to the lamp. An HID lamp will not conduct a current until it is first “struck” or ignited by applying a strike” voltage to its terminals. However, once an electrical arc is struck inside the HID lamp that terminal voltage may fall to a run voltage. The run voltage may be a small fraction of the strike voltage over a relatively wide range of input currents.

During operation an HID lamp produces a significant amount of heat. As the temperature of the lamp increases so does the strike voltage required to ignite the lamp. The strike voltage required to ignite a “hot” HID lamp can prove damaging to the lamp reducing its life expectancy. Consequently the lifespan of an HID lamp is improved when it is cooled before it is reignited.

Addressing this issue, projectors are configured to cool their lamps for a specified time upon shut-down. However, if a projector shut-down, unplugged from its wall socket, plugged back in, and restarted, it may not know to cool its lamp before attempting a strike. Often, this leads to one or more unsuccessful strikes and re-strikes reducing the lamp's lifespan.

### DRAWINGS

FIG. 1 is a schematic view of an environment in which various embodiments may be implemented

FIG. 2 is an exemplary block diagram illustrating logical and physical components operating on a projector according to an embodiment.

FIG. 3 is an exemplary block diagram illustrating logical and physical components of a light engine according to another embodiment.

FIGS. 4A-4D illustrate various projector orientations that can be detected according to an embodiment.

FIGS. 5-6 are exemplary flow diagrams illustrating steps for implementing various embodiments.

### DETAILED DESCRIPTION

INTRODUCTION: Various embodiments described below operate in an automated fashion to initiate a cooling routine according to a detected projector orientation. When a projector is determined to be in a portable orientation upon start-up, a longer pre-cooling routine is selected than if the projector was detected to be in a non-portable orientation. Upon start-up this increases the likelihood that a portably oriented projector will successfully ignite its lamp. When a projector is determined to be in a portable orientation upon shut-down, a shorter cooling routine is selected than if the projector was detected to be in a non-portable orientation. Upon shut down, this allows a portable projector to be more quickly packed and taken away following use. Users of a non-portable projector care less if at all about a cooling duration following shut-down. Moreover, users of non-portable projectors may object to the added noise produced when the projector performs a quick cool-down.

A more detailed explanation of the various cooling routines is provided in the following description which is broken into sections. The first section, labeled “environment” describes an exemplary environment in which embodiments may be implemented. The second section, labeled “components,” describes exemplary logical and physical components used to implement various embodiments. The third section, labeled “operation,” describes exemplary method steps for implementing various embodiments.

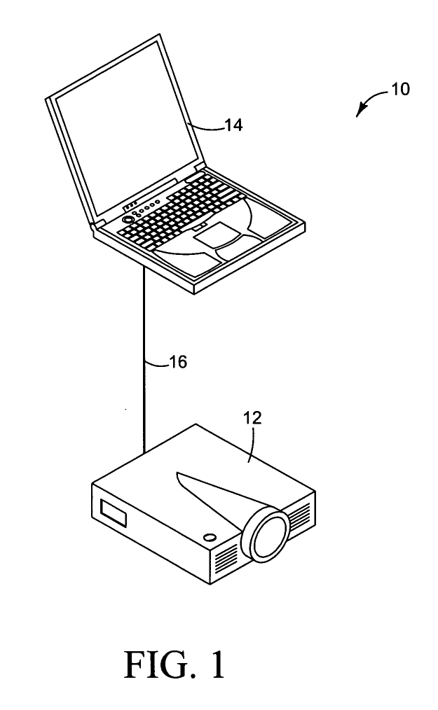

ENVIRONMENT: Although the various embodiments of the invention disclosed herein will be described with reference to the environment 10 shown in FIG. 1, the invention is not limited to use with environment 10. The invention may be implemented in any environment in which it may be desirable to implement a cooling routine selected based on a device orientation. Referring to FIG. 1, environment 10 includes a projector 12 and a video source 14. Projector 12 represents generally any device capable of using light to project an image onto a screen. While projector 12 will be described as a digital projector below, it may instead be a conventional slide or film projector or any other type of projector that relies on a lamp.

Video source 14 represents generally any device capable of supplying an electronic representation of an image or motion picture to be projected. As shown, video source 14 is a laptop computer. Alternatively, video source may be a DVD player, a VCR, a digital video player, or any other device capable of sending video data representative of an image or motion video to projector 12.

Link 16 interconnects projector 12 with video source 14. Link 16 represents generally one or more of a cable, wireless, fiber optic, or remote connection via a telecommunication link, an infrared link, a radio frequency link, or any other connector or system that provides electronic communication between devices 12 and 14. Link 16 may represent an intranet, the Internet, or a combination of both. The path followed by link 16 between devices 12 and 14 in the schematic view of FIG. 1, represents the logical communication path between these devices, not necessarily the physical path between the devices.

While implementation of various exemplary embodiments are described with respect to projector 12, implementation is not so limited to projectors. As will become apparent, embodiments may be implemented with respect to any device that includes (1) a component that serves as or is otherwise affected by a heat source, (2) the capability to cool that component, and (3) the capability of being utilized in tow or more orientations. Projector 12 is but one device that meets these criteria.

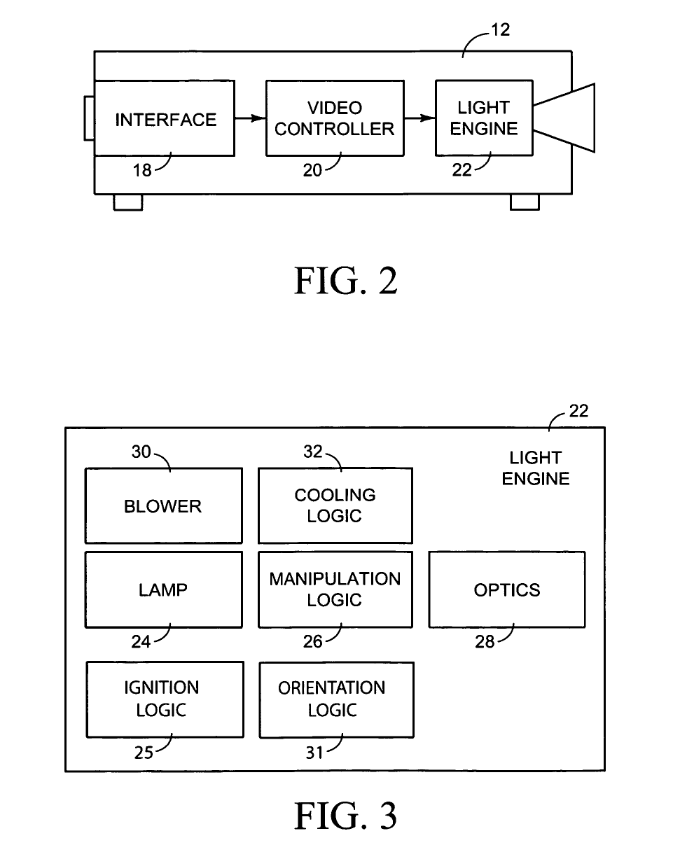

COMPONENTS: The logical components of various embodiments of will now be described with reference to the exemplary block diagram of FIG. 2. In this example of FIG. 2, projector 12 is a digital projector and includes interface 18, video controller 20, and light engine 22. Interface 18 represents generally any combination of hardware and/or programming configured to receive input video data from a video source device such as device 12 in FIG. 1. Video data can be an electronic signal representative of an image or motion video to be projected. Video controller 20 represents any combination of hardware and/or programming capable of converting video data received at interface 18 into pixel and color data supplied to light engine 22. Light engine 22 represents a combination of hardware and/or programming capable of manipulating light to project an image or motion video representative of the pixel color data received from video controller 20.

There are at least three different technologies that light engine 22 might implement: Liquid Crystal Display (LCD), DIGITAL MICROMIRROR DEVICE (DMD), and Liquid Crystal on Silicon (LCOS). It is noted that implementation of various embodiments is not limited to the technology implemented by light engine 22. The technologies listed are merely provided as examples as each utilizes a heat generating lamp that can be cooled according to the various exemplary embodiments described herein.

An LCD light engine breaks down the light from a lamp into red, green and blue components. Each color is then polarized and sent to one or more liquid crystal panels that turn the pixels on and off, depending on the image being produced. An optic system then recombines the three color signals and projects the final image to a screen or other surface.

A DMD light engine directs white light from a lamp onto a color wheel producing red, green, blue and white light. The colored light is then passed to a Digital Micromirror Device (DMD), which is an array of miniature mirrors capable of tilting back-and-forth on a hinge. Each mirror corresponds to a pixel of the projected image. To turn a pixel on, the respective mirror reflects the light into the engine's optics. To turn a pixel off, the mirror reflects the light away from the optics.

A LCOS light engine combines LCD panels with a low cost silicon backplane to obtain resolutions that are typically higher than LCD or DLP projectors. The LCOS light engine has a lamp whose light is sent to a prism, polarized, and then sent to a LCOS chip. The LCOS chip reflects the light into the engine's optics where the color signals are recombined to form the projected image.

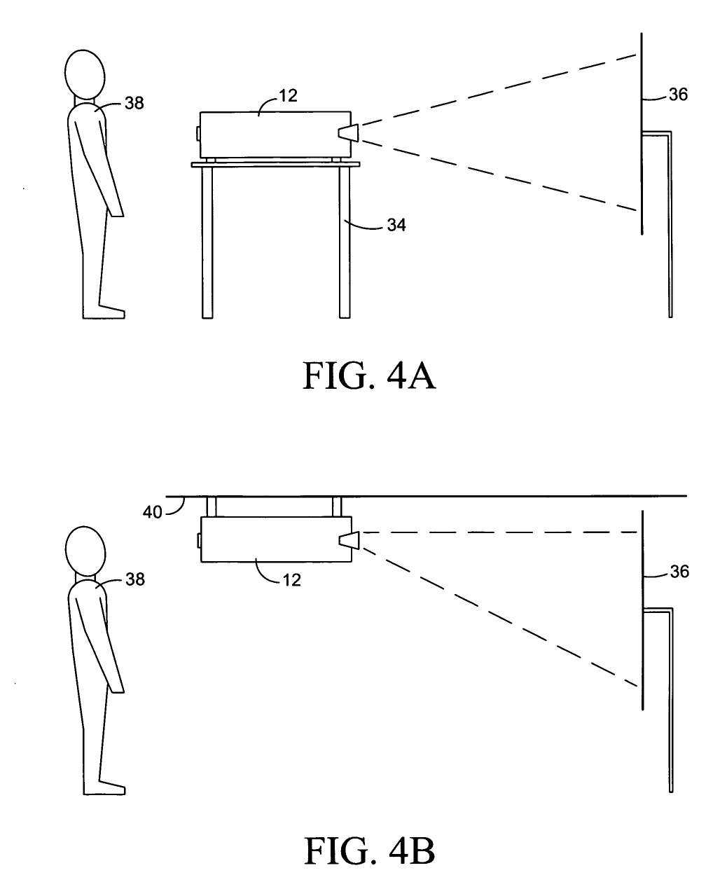

FIG. 3 is a schematic block diagram illustrating exemplary components of light engine 22. In the example of FIG., 3, light engine 22 includes lamp 24, ignition logic 25, manipulation logic 26, optics 28, blower 30, orientation logic 31, and cooling logic 32. Lamp 24 represents generally any light source capable of being utilized to project an image. It is expected that lamp 24 will include high intensity discharge (HID) lamp to project or throw images onto a screen as well as logic for powering the HID lamp. A HID lamp has terminal voltage characteristics that vary depending upon the immediate history and the frequency of a stimulus such as an AC signal. An HID lamp will not conduct a current until it is first “struck” or ignited by applying a “strike” voltage to its terminals. However, once an electrical arc is struck inside the HID lamp that terminal voltage may fall to a run voltage. The run voltage may be a small fraction of the strike voltage over a relatively wide range of input currents.

During operation an HID lamp produces a significant amount of heat. As the temperature of the lamp increases so does the strike voltage required to ignite the lamp. Often the strike voltage required to ignite a “hot” HID lamp cannot be achieved using a standard household AC signal. Consequently the HID lamp may be cooled before it can be reignited.

Ignition logic 25 represents generally any combination of hardware and/or programming responsible for attempting to ignite and re-ignite lamp 24 and for detecting if an ignition or re-ignition attempt has been successful. When lamp 24 fails to ignite it will not draw a current. Ignition logic 25 then can determine a successful ignition upon detecting that lamp 22 is drawing a current or operating at a run voltage that is indicative of a successful ignition.

Manipulation logic 26 represents any combination of hardware capable of manipulating light from lamp 24 to project the pixels and color according to the pixel and color data received from video converter 20. As mentioned above, manipulation logic may utilize any one of a number of available technologies such as LCD, DMD, and LCOS. Optics 28 represent one or more lenses configured to focus pixels and color onto a screen or other target surface.

Blower 30 represents generally one or more fans configured to force air over lamp 24 and any other physical components of projector 12 that may benefit from active heat dissipation. Orientation logic 31 represents generally any combination of hardware and/or programming capable of detecting or otherwise identifying an orientation of projector 12. Cooling logic 32 represents generally any combination of hardware and/or programming capable of controlling blower 30 and lamp 24 to effect a cooling routine selected according to an orientation detected by orientation logic 31. A more detailed description of various cooling routines in the following section.

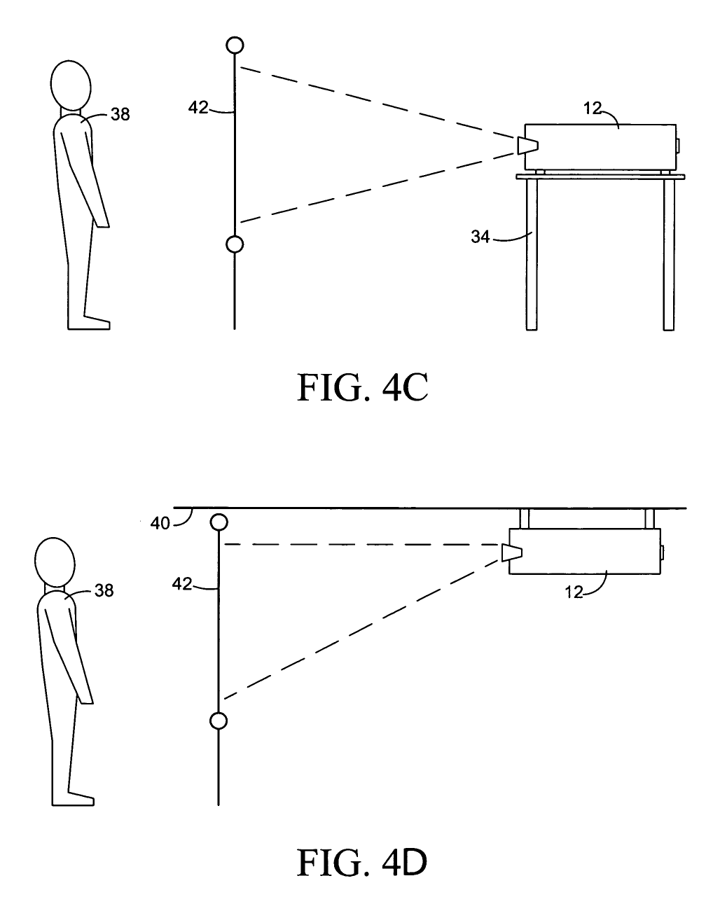

FIGS. 4A-4D illustrate exemplary projector orientations. In FIG. 4A, projector 12 is in a “front table” orientation meaning that it is placed in a table 34 or other surface facing screen 36 and is readily accessible by audience member 38. In this orientation, projector 12 casts a normal, non-inverted, and non-reversed image on screen 36. In FIG. 4B, projector 12 is in a “front ceiling” mode meaning that it is inverted and physically coupled to ceiling 40. Here projector 12 casts an inverted image on screen 36. In FIG. 4C, projector 12 is in a “rear-table” mode meaning that it is placed on a table 34 or other surface on the opposing side of screen 42 from audience member 38. In this orientation, projector 12 casts a non-inverted, but reversed image on screen 42. In FIG. 4D, projector 12 is in a “rear ceiling” mode meaning that it is inverted and physically coupled to ceiling 40 an located on the opposing side of screen 42 from audience member 38. Here projector 12 casts an inverted and reversed image on screen 42.

It can be said that the “front table” orientation is a portable orientation in which projector 12 is more readily accessible and moved. One or more of the other orientations illustrated in FIGS. 4B-4C or an orientation not shown may also be deemed to be a portable orientation. Through a user interface or other means (not shown) supplied by projector 12, a user selects an orientation. Manipulation logic 36 then performs its tasks based on that orientation. In other words it causes a normal projection, an inverted projection, a reversed projection, or an inverted and reversed projection. Upon start-up and shut-down of projector 12, orientation logic 31 identifies whether or not projector 12 is in a portable orientation so that cooling logic 32 can implement an appropriate cooling routine chosen based on that orientation. Orientation logic 31 perform its tasks by identifying an orientation selected by a user through a user interface (not shown) supplied by projector 12.

In addition to identifying a user specified orientation, a more automated approach may be implemented. For example, projector 12 may include an accelerometer (not shown), also known as a tilt sensor, for use in determining when projector 12 is aimed off a horizontal axis. In addition to using information from the accelerometer to correct the projected image, projector 12 can use this information to assume that is projecting from a ceiling and is in a non-portable orientation.

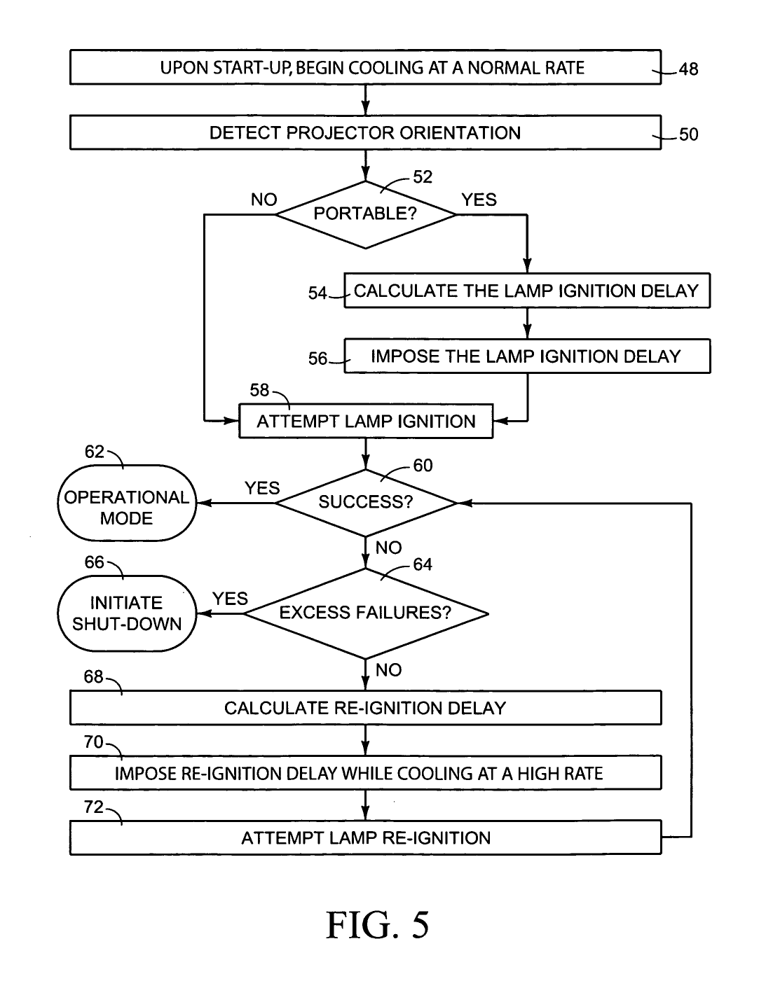

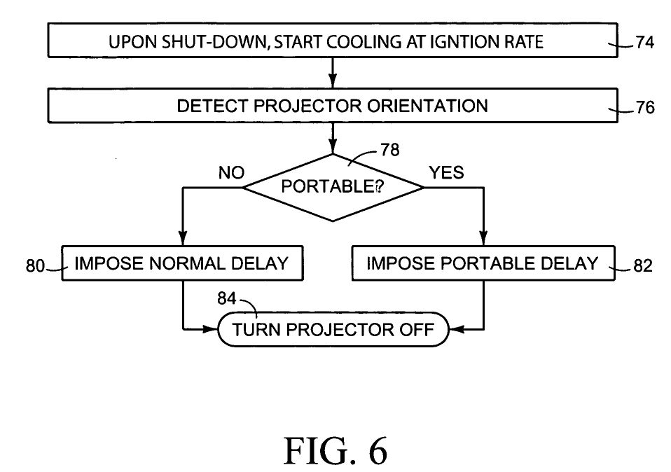

OPERATION: FIGS. 5-6 illustrate the operation of various embodiments. Starting with FIG. 5, a projector start-up routine is shown. Upon start-up, cooling is started at a normal default rate. For example, the blower 30 (FIG. 3) is started at normal default operating speed (step 48). The orientation of the projector is detected (step 50). If the orientation is detected to be portable (step 52) then a lamp ignition delay is calculated (step 54) and then imposed (step 56). Following the delay imposed in step 56 or if the orientation is detected not to be portable in step 52, lamp ignition is attempted (step 58).

Referring back to FIG. 3 for an example, cooling logic 32 is responsible for starting blower 30 upon projector start-up in step 48. Orientation logic 31 is responsible for step 50. Cooling logic 32 is responsible for performing steps 52 and 54 as well as instructing ignition logic 25 to attempt ignition of lamp 24 in step 58.

A lamp ignition delay is a time duration calculated based on a duration for which the projector has been turned off, an ambient temperature, and one or more constants. Where the duration for which the projector has been turned off is sufficiently long, the lamp ignition delay is set to zero. The following provides an example of how cooling logic 32 might calculate a lamp ignition delay. First, it is determined whether the duration for which the projector has been turned off (T_{off}) is less than a particular duration. That duration, for example, may be a constant or it may be dependent upon an ambient temperature and one or more constants. For example it may be determined whether T_{off}<T_{delay} where T_{delay}=a set duration such as four minutes or T_{delay}=Xₘᵢₙᵤₜₑₛ+Y(T_{ambient}−Z)_{seconds}. T_{ambient} is the ambient temperature and X, Y, and Z are constants. In one embodiment X=7, Y=15, and Z=23 where T_{ambient} is in degrees centigrade.

If T_{off} is not less than T_{delay} then the lamp ignition delay is calculated as zero in step 54. Otherwise the lamp ignition delay (LID) may be calculated as a constant such as fifty seconds or according to the following exemplary formula: LID =[A(T_{delay}−T_{off})/T_{delay}] * [B+C(T_{ambient}−D)] seconds. A, B, C, and D are constants. In one embodiment A=55, B=1, C=0.018, and D=23. Where, as indicated above, the ambient temperature is a factor in determining the lamp ignition delay, cooling logic 32 will either include or have access to a temperature sensor.

Following the attempted lamp ignition in step 58, it is determined if lamp 24 was successfully ignited (step 60). If ignition was a success, the projector enters an operational mode (step 62). If not, a re-ignition routine is initiated in steps 64-72. A failed ignition attempt in step 58 may be due to an insufficient lamp ignition delay. Such may be a result of the projector being unplugged and plugged back in. In that case, the value for T_{off} will not be known and may be presumed to be greater than T_{delay}. Consequently, the lamp ignition delay will be set to zero and lamp ignition will be attempted prematurely in step 58.

The re-ignition routine involves first determining if there have been excess lamp re-ignition failures (step 64). In one embodiment, an excess number of failures is two which can be indicative of a lamp defect. If there have been an excess number of failures, projector shut-down is initiated (step 66). Otherwise, a lamp re-ignition delay is calculated (step 68). The lamp re-ignition delay may be imposed while cooling at a high rate (step 70). For example, the blower may be set to operate at high speed. This high cooling rate or is greater than the normal default rate of step 48. Lamp re-ignition is attempted (step 72), and the process skips back to step 60 to determine if the attempt was a success. Use of the high speed when attempting lamp re-ignition rather than ignition helps keep noise at a minimum. Alternatively, the blower may be operating at a normal default speed during the lamp re-ignition delay.

The lamp re-ignition delay (LRID) can be a constant, it can be calculated as a function of a number of unsuccessful re-strike attempts, or it can be calculated as a function of the ambient temperature and one or more constants. For example, LRID=20 seconds on a first re-ignition attempt and fifteen seconds on a second re-ignition attempt. Alternatively, LRID=E+(T_{ambient}−F)/G seconds, where E, F, and G are constants. In one embodiment E=30, F=23, and G=2.

Referring back to FIG. 3, ignition logic 25 is responsible for steps 60-66 and 72, while cooling logic 32 is responsible for steps 68 and 70.

Moving to FIG. 6, a lamp shut-down routine is described. Upon shut-down, cooling is started at an ignition rate (step 74). If shut-down is initiated after entering operational mode in step 62 of FIG. 5, the ignition rate is the normal default rate of step 48. If shut-down is initiated following excess re-ignition attempts in step 66 of FIG. 5, then the ignition rate is the higher cooling rate of step 70. Step 74, for example, can involve operating the blower at a normal default speed or at a high speed.

Projector orientation is detected (Step 76). If the orientation is detected to not be portable (step 78) then a standard delay is imposed (step 80). Otherwise, where a portable orientation is detected (step 78), a portable delay is imposed (step 82). Following imposition of either the portable or normal delay, the projector is powered off (step 84).

The term “normal” as opposed to “portable” is selected only to differentiate a default cooling delay from a portable cooling delay—the portable cooling routine being used upon detection of a portable orientation in step 78. The term “normal” has no other intended meaning. A normal delay can be calculated as a constant or as a function of the ambient temperature and a constant. In one embodiment, the normal delay is set to sixty-eight seconds. In another it is set to forty seconds. A portable delay can be calculated as a constant or as a function of the ambient temperature and a constant. In one embodiment, the portable delay is set to ten seconds which is substantially less than the sixty-eight second or forty second normal delay.

In an alternative embodiment, the cooling may be imposed in step 74 at a rate that is dependent upon the orientation of the projector detected in step 76. For example, when a portable orientation is detected, the blower may be operated at a high speed in step 74. Otherwise the blower is operated at a normal default speed. For a portable orientation, it is noted that cooling is implemented at a high rate for a relatively short duration. This improves cooling while keeping reducing the time a user is exposed to any additional noise.

Referring back to FIG. 3, cooling logic 32 is responsible for starting blower 30 upon projector shut-down in step 74. Orientation logic 31 is responsible for step 76. Cooling logic 32 is responsible for performing steps 78-82.

CONCLUSION: While the above examples refer implementing various embodiments with a projector, implementation is not limited to such use. Embodiments may be implemented with respect to any device that includes (1) a component that serves as or is otherwise affected by a heat source, (2) the capability to cool that component, and (3) the capability of being utilized in tow or more orientations. A projector is but one device that meets these criteria

The environment 10 of FIG. 1 illustrates an exemplary environment in which embodiments may be implemented. Implementation, however, is not limited to environment 10. The block diagrams of FIGS. 2-3 show the architecture, functionality, and operation of various embodiments of the present invention. A number of the blocks are defined at least in part as programs. Each of those blocks may represent in whole or in part a module, segment, or portion of code that comprises one or more executable instructions to implement the specified logical function(s). Each block may also represent a circuit or a number of interconnected circuits to implement the specified logical function(s).

Also, the present invention can be embodied at least in part, in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes, hard drives or a portable compact disc.

Although the flow diagrams of FIGS. 5-6 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A device cooling method, comprising:
upon device start-up, detecting a device orientation; and
initiating a device component cooling routine according to the detected orientation.

2. The method of claim 1, wherein the device is a projector, and the device component includes a projector lamp.

3. The method of claim 2, further comprising upon start-up running a blower at a first speed, the blower operable to help cool the projector lamp; and
wherein, If a portable orientation is detected, then initiating device component cooling routine includes calculating a lamp ignition delay and imposing the lamp ignition delay allowing the blower to cool the lamp.

4. The method of claim 3, wherein calculating a lamp ignition delay comprises calculating a lamp ignition delay as a function of a duration for which the projector has been turned off and an ambient temperature.

5. The method of claim 3, further comprising:
attempting a lamp ignition;
upon a successful lamp ignition, entering an operational mode;
upon an unsuccessful lamp ignition, calculating a re-ignition delay, imposing the re-ignition delay with the blower operating at a second speed faster than the first speed, and attempting a lamp re-ignition.

6. The method of claim 5, wherein calculating a re-ignition delay comprises calculating a re-ignition delay as a function of an ambient temperature.

7. The method of claim 5, further comprising repeating the acts of calculating a re-ignition delay, imposing the re-ignition delay with the blower operating at a high speed, and attempting a lamp re-ignition upon an unsuccessful re-ignition.

8. The method of claim 7, further comprising initiating a shut-down routine following an excessive number of re-ignition failures.

9. The method of claim 8, wherein initiating a shut-down routine comprises:
running the blower at the second speed;
imposing a delay according to the detected orientation of the projector allowing the blower to cool the lamp; and
turning off the projector.

10. The method of claim 9, wherein imposing a delay comprises, if the projector is detected to be in a portable orientation then imposing a shorter delay than if the projector is detected to be in a different orientation.

11. A computer readable medium having computer executable instructions for:
upon device start-up, detecting a device orientation; and
initiating a device component cooling routine according to the detected orientation.

12. The medium of claim 11, wherein the device is a projector, and the device component includes a projector lamp.

13. The medium of claim 12, having further instructions for upon start-up causing a blower to operate at a first speed, the blower operable to help cool the projector lamp; and
wherein the instructions for initiating the device component cooling routine when a portable orientation is detected include instructions for calculating a lamp ignition delay and imposing the lamp ignition delay allowing the blower to cool the lamp.

14. The medium of claim 13, wherein the instructions for calculating a lamp ignition delay include instructions for calculating a lamp ignition delay as a function of a duration for which the projector has been turned off and an ambient temperature.

15. The medium of claim 13, having further instructions for:
attempting a lamp ignition;
upon a successful lamp ignition, entering an operational mode;
upon an unsuccessful lamp ignition, calculating a re-ignition delay, imposing the re-ignition delay with the blower operating at a second speed faster than the first speed, and attempting a lamp re-ignition.

16. The medium of claim 15, wherein the instructions for calculating a re-ignition delay include instructions for calculating a re-ignition delay as a function of an ambient temperature.

17. The medium of claim 15, having further instructions for re-executing the instructions for calculating a re-ignition delay, imposing the re-ignition delay with the blower operating at a high speed, and attempting a lamp re-ignition upon an unsuccessful re-ignition.

18. The medium of claim 17, having further instructions for initiating a shut-down routine following an excessive number of re-ignition failures.

19. The medium of claim 18, wherein the instructions for initiating a shut-down routine include instructions for:
running the blower at the second speed;
imposing a delay according to the detected orientation of the projector allowing the blower to cool the lamp; and
turning off the projector.

20. The medium of claim 19, wherein the instructions for imposing a delay include, imposing a shorter delay if the projector is detected to be in a portable orientation then than if the projector is detected to be in a different orientation.

21. A system for device cooling comprising:
orientation logic operable to detect a device orientation; and
cooling logic operable to initiate a device component cooling routine according to the detected orientation.

22. The system of claim 21, wherein the device is a projector and the device component includes a projector lamp.

23. The system of claim 22, wherein the cooling logic is operable to, cause a blower to operate at a first speed upon projector start-up, the blower operable to help cool the projector lamp; and
wherein, when a portable orientation is detected by the orientation logic, the cooling logic is operable to initiate a device component routine that includes calculating a lamp ignition delay and imposing the lamp ignition delay allowing the blower to cool the lamp.

24. The system of claim 23, wherein the cooling logic is operable to calculate a lamp ignition delay by calculating a lamp ignition delay as a function of a duration for which the projector has been turned off and an ambient temperature.

25. The system of claim 23:
further comprising ignition logic operable to attempt a lamp ignition and detect a an unsuccessful attempt;
wherein upon a detection of an unsuccessful lamp ignition, the cooling logic is operable to calculate a re-ignition delay, impose the re-ignition delay with the blower operating at a second speed faster than the first speed;
and wherein the ignition logic is further operable to attempt a lamp re-ignition following the re-ignition delay.

26. The system of claim 25, wherein the cooling logic is operable to calculate a re-ignition delay by calculating a re-ignition delay as a function of an ambient temperature.

27. The system of claim 25, wherein:
the ignition logic is operable to detect an unsuccessful re-ignition attempt;
the cooling logic is operable to repeatedly calculate a re-ignition delay and impose the re-ignition delay following an unsuccessful re-ignition attempt with the blower operating at a high speed; and
the ignition logic is further operable to repeat the re-ignition attempt following a repeated re-ignition delay.

28. The system of claim 27, wherein the cooling logic is operable to initiate a shut-down routine following an excessive number of re-ignition failures.

29. The system of claim 28, wherein the cooling logic is operable to imitate a shut-down routine by running the blower at the second speed and imposing a delay according to the detected orientation of the projector allowing the blower to cool the lamp before the projector is turned off.

30. The system of claim 29, wherein, when the projector is detected to be in a portable orientation, the cooling logic is operable to impose a shorter delay than if the projector is detected to be in a different orientation.

31. A system for projector cooling comprising:
a means for detecting a projector orientation; and
a means for initiating a lamp cooling routine according to the detected orientation.

32. A projector, comprising:
a video controller operable to convert video data into pixel and color data.
a light engine operable to receive the pixel and color data and to manipulate light to project pixels and color representative of the pixel and light data; and
wherein the light engine includes:
a lamp;
a blower operable to cool the lamp;
orientation logic operable to detect a projector orientation; and
cooling logic operable to initiate a lamp cooling routine utilizing the blower according to the detected orientation.
